(19) United States
(12) Patent Application Publication
(10) Pub. No.: US 2024/0098674 A1
(43) Pub. Date: Mar. 21, 2024

(54) METHOD, DEVICE AND COMPUTER PROGRAM PRODUCT FOR WIRELESS COMMUNICATION

(71) Applicant: ZTE Corporation, Shenzhen (CN)

(72) Inventor: Menghan Wang, Shenzhen (CN)

(73) Assignee: ZTE Corporation, Shenzhen (CN)

(21) Appl. No.: 18/521,719

(22) Filed: Nov. 28, 2023

Related U.S. Application Data
(63) Continuation of application No. PCT/CN2021/105559, filed on Jul. 9, 2021.

(51) Int. Cl. H04W 60/00

(52) U.S. Cl. CPC H04W 60/00; H04W 84/042

(57) ABSTRACT

Method, device and computer program product for wireless communication are provided. A method includes: transmitting, by a wireless communication terminal to an access and mobility management node, at least one piece of intended Single-network slice Selection Assistant Information, S-NSSAI, in at least one of requested network slice Selection Assistant Information, NSSAI, or in an extended information element; and receiving, by the wireless communication terminal from the access and mobility management node, prioritization information of at least one of Visitor Public Land Mobile Networks, VPLMNs, or access technology, wherein the prioritization information is generated according to the at least one piece of intended S-NSSAI in the at least one of requested NSSAI or in the extended information element.

### CROSS-REFERENCE TO RELATED APPLICATION

This application claims priority as a Continuation of PCT/CN2021/105559, filed on Jul. 9, 2021, titled “METHOD, DEVICE AND COMPUTER PROGRAM PRODUCT FOR WIRELESS COMMUNICATION”, published as WO 2023/279387 A1, the entirety of which is incorporated herein by reference.

### TECHNICAL FIELD

This document is directed generally to wireless communications, in particular to 5^{th} generation (5G) wireless communications.

### BACKGROUND

A network slice refers to a logical network that has specific network capabilities and network characteristics. A network slice instance refers to a set of Network Function instances and the required resources (e.g. compute, storage and networking resources), and the set of Network Function instances and the required resources form a deployed network slice.

A roaming UE (user equipment) may stay in an area covered by different PLMNs (Public Land Mobile Networks). Each PLMN provides different services via different network slices. The UE can subscribe several services. When a roaming UE activates a service and/or application requiring a network slice not offered by the serving VPLMN (Visitor Public Land Mobile Network) but available in the area from other VPLMN(s), it is unclear how the HPLMN (Home Public Land Mobile Network) provides the UE the prioritization information of the VPLMNs and/or access technology based on the network slice information, in which with the prioritization information, the UE may register for the network slice.

### SUMMARY

The present disclosure relates to methods, devices, and computer program products for providing the UE with the prioritization information of the VPLMNs and/or access technology based on the network slice information, in which with the prioritization information, the UE may register for the intended network slice.

One aspect of the present disclosure relates to a wireless communication method. In an embodiment, the wireless communication method includes: transmitting, by a wireless communication terminal to an access and mobility management node, at least one piece of intended Single-network slice Selection Assistant Information, S-NSSAI, in at least one of requested network slice Selection Assistant Information, NSSAI, or in an extended information element; and receiving, by the wireless communication terminal from the access and mobility management node, prioritization information of at least one of Visitor Public Land Mobile Networks, VPLMNs, or access technology, wherein the prioritization information is generated according to the at least one piece of intended S-NSSAI in the at least one of requested NSSAI or in the extended information element.

Another aspect of the present disclosure relates to a wireless communication method. In an embodiment, the wireless communication method includes: receiving, by an access and mobility management node from a wireless communication terminal, at least one piece of intended Single-network slice Selection Assistant Information, S-NSSAI, in at least one of requested network slice Selection Assistant Information, NSSAI, or in an extended information element; and acquiring, by the access and mobility management node from a managing node, prioritization information of at least one of Visitor Public Land Mobile Networks, VPLMNs, or access technology by providing the managing node with the at least one piece of intended S-NSSAI in the at least one of requested NSSAI or in the extended information element.

Another aspect of the present disclosure relates to a wireless communication method. In an embodiment, the wireless communication method includes: transmitting, by a unified data node, prioritization information of at least one of Visitor Public Land Mobile Networks, VPLMNs, or access technology to an access and mobility management node or a wireless communication terminal, wherein the prioritization information is generated according to the at least one piece of the intended S-NSSAI provided by the access and mobility management node.

Another aspect of the present disclosure relates to a wireless communication method. In an embodiment, the wireless communication method includes: generating, by an application node, prioritization information according to at least one piece of intended S-NSSAI.

Another aspect of the present disclosure relates to a wireless communication method. In an embodiment, the wireless communication method includes: generating, by a network node, prioritization information of at least one of Visitor Public Land Mobile Networks, VPLMNs, or access technology according to at least one piece of intended Single-network slice Selection Assistant Information, S-NSSAI, provided by an access and mobility management node or a wireless communication terminal.

Another aspect of the present disclosure relates to a wireless communication method. In an embodiment, the wireless communication method includes: transmitting, by a first control node to a second control node, at least one piece of intended Single-network slice Selection Assistant Information, S-NSSAI, provided by an access and mobility management node to retrieve prioritization information of at least one of Visitor Public Land Mobile Networks, VPLMNs, or access technology.

Another aspect of the present disclosure relates to a wireless communication method. In an embodiment, the wireless communication method includes: generating, by a second control node, prioritization information of at least one of Visitor Public Land Mobile Networks, VPLMNs, or access technology according to at least one piece of intended Single-network slice Selection Assistant Information, S-NSSAI, from a first control node.

Another aspect of the present disclosure relates to a wireless communication terminal. In an embodiment, the wireless communication terminal includes a communication unit and a processor. The processor is configured to: transmit, to an access and mobility management node, at least one piece of intended Single-network slice Selection Assistant Information, S-NSSAI, in at least one of requested network slice Selection Assistant Information, NSSAI, or in an extended information element; and receive, from the access and mobility management node, prioritization information of at least one of Visitor Public Land Mobile Networks, VPLMNs, or access technology, wherein the prioritization information is generated according to the at least one piece of intended S-NSSAI in the at least one of requested NSSAI or in the extended information element.

Another aspect of the present disclosure relates to a wireless communication node. In an embodiment, the wireless communication node includes a communication unit and a processor. The processor is configured to: receive, from a wireless communication terminal, at least one piece of intended Single-network slice Selection Assistant Information, S-NSSAI, in at least one of requested network slice Selection Assistant Information, NSSAI, or in an extended information element; and acquire, from a managing node, prioritization information of at least one of Visitor Public Land Mobile Networks, VPLMNs, or access technology by providing the managing node with the at least one piece of intended S-NSSAI in the at least one of requested NSSAI or in the extended information element.

Another aspect of the present disclosure relates to a wireless communication node. In an embodiment, the wireless communication node includes a communication unit and a processor. The processor is configured to: transmit prioritization information of at least one of Visitor Public Land Mobile Networks, VPLMNs, or access technology to an access and mobility management node or a wireless communication terminal, wherein the prioritization information is generated according to the at least one piece of the intended S-NSSAI provided by the access and mobility management node.

Another aspect of the present disclosure relates to a wireless communication node. In an embodiment, the wireless communication node includes a communication unit and a processor. The processor is configured to: generate prioritization information according to at least one piece of intended S-NSSAI.

Another aspect of the present disclosure relates to a wireless communication node. In an embodiment, the wireless communication node includes a communication unit and a processor. The processor is configured to: generate prioritization information of at least one of Visitor Public Land Mobile Networks, VPLMNs, or access technology according to at least one piece of intended Single-network slice Selection Assistant Information, S-NSSAI, provided by an access and mobility management node or a wireless communication terminal.

Another aspect of the present disclosure relates to a wireless communication node. In an embodiment, the wireless communication node includes a communication unit and a processor. The processor is configured to: transmit, to a second control node, at least one piece of intended Single-network slice Selection Assistant Information, S-NSSAI, provided by an access and mobility management node to retrieve prioritization information of at least one of Visitor Public Land Mobile Networks, VPLMNs, or access technology.

Another aspect of the present disclosure relates to a wireless communication node. In an embodiment, the wireless communication node includes a communication unit and a processor. The processor is configured to: generate prioritization information of at least one of Visitor Public Land Mobile Networks, VPLMNs, or access technology according to at least one piece of intended Single-network slice Selection Assistant Information, S-NSSAI, from a first control node.

Various embodiments may preferably implement the following features:

Preferably, the requested NSSAI comprises at least one of: at least one piece of allowed S-NSSAI; or at least one piece of S-NSSAI included in Configured NSSAI for a serving Public Land Mobile Network, PLMN. The extended information element comprises at least one of: at least one piece of rejected S-NSSAI for a current PLMN; or at least one piece of rejected S-NSSAI for a current Registration Area. The Configured NSSAI may be configured by a serving PLMN or may be a default Configured NSSAI configured by the HPLMN. The Configured NSSAI may include configuration for network slice selection.

Preferably, the requested NSSAI or the extended information element comprises at least one of: at least one piece of allowed S-NSSAI; at least one piece of S-NSSAI included in Configured NSSAI for a serving PLMN; at least one piece of rejected S-NSSAI for a current PLMN; or at least one piece of rejected S-NSSAI for a current Registration Area.

Preferably, the wireless communication terminal is configured to transmit an indication indicating that the wireless communication terminal supports PLMN selection based on the prioritization information.

Preferably, the access and mobility management node is configured to receive an indication indicating that the wireless communication terminal supports PLMN selection from the wireless communication terminal based on the prioritization information.

Preferably, the access and mobility management node is configured to provide the managing node the at least one piece of the intended S-NSSAI in the requested NSSAI or the extended information element comprising at least one of: at least one piece of allowed S-NSSAI; at least one piece of rejected S-NSSAI for a current PLMN; or at least one piece of rejected S-NSSAI for a current Registration Area.

Preferably, the access and mobility management node is configured to provide the managing node the at least one piece of the intended S-NSSAI in the requested NSSAI or the extended information element comprising at least one of: at least one piece of rejected S-NSSAI for a current PLMN; or at least one piece of rejected S-NSSAI for a current Registration Area.

Preferably, the access and mobility management node is configured to transmit the prioritization information to the wireless communication terminal.

Preferably, the unified data node is configured to generate the prioritization information according to the at least one piece of the intended S-NSSAI provided by the access and mobility management node.

Preferably, the unified data node is configured to transmit the at least one piece of the intended S-NSSAI provided by the access and mobility management node to an application node to retrieve the prioritization information from the application node.

Preferably, the application node is configured to receive the at least one piece of the intended S-NSSAI from a unified data node and transmit the prioritization information to the unified data node.

Preferably, the prioritization information comprises information of at least one of a current PLMN or a VPLMN.

Preferably, the network node is configured to provide the prioritization information to the access and mobility management node or the wireless communication terminal.

Preferably, the first control node is configured to select the second control node to retrieve the prioritization information.

Preferably, the second control node is configured to transmit the prioritization information to the first control node.

The present disclosure relates to a computer program product including a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows 5G System (5GS) architecture according to an embodiment of the present disclosure.

FIG. 2 shows a procedure for a UE registering for a set of network slices according to an embodiment of the present disclosure.

FIG. 3 shows a schematic diagram of network architecture according to an embodiment of the present disclosure.

FIGS. 4A and 4B show a schematic diagram of a registration procedure according to an embodiment of the present disclosure.

FIG. 5 shows a schematic diagram of network architecture according to an embodiment of the present disclosure.

FIGS. 6A and 6B show a schematic diagram of a registration procedure according to an embodiment of the present disclosure.

FIG. 7 shows a schematic diagram of network architecture according to an embodiment of the present disclosure.

FIGS. 8A and 8B show a schematic diagram of a registration procedure according to an embodiment of the present disclosure.

FIG. 9 shows a schematic diagram of network architecture according to an embodiment of the present disclosure.

FIGS. 10A and 10B show a schematic diagram of a registration procedure according to an embodiment of the present disclosure.

FIG. 11 shows an example of a schematic diagram of a wireless communication terminal according to an embodiment of the present disclosure.

FIG. 12 shows an example of a schematic diagram of a wireless communication node according to an embodiment of the present disclosure.

FIG. 13 shows a flowchart of a wireless communication method according to an embodiment of the present disclosure.

FIG. 14 shows a flowchart of another wireless communication method according to an embodiment of the present disclosure.

FIG. 15 shows a flowchart of another wireless communication method according to an embodiment of the present disclosure.

FIG. 16 shows a flowchart of another wireless communication method according to an embodiment of the present disclosure.

FIG. 17 shows a flowchart of another wireless communication method according to an embodiment of the present disclosure.

FIG. 18 shows a flowchart of another wireless communication method according to an embodiment of the present disclosure.

FIG. 19 shows a flowchart of another wireless communication method according to an embodiment of the present disclosure.

### DETAILED DESCRIPTION

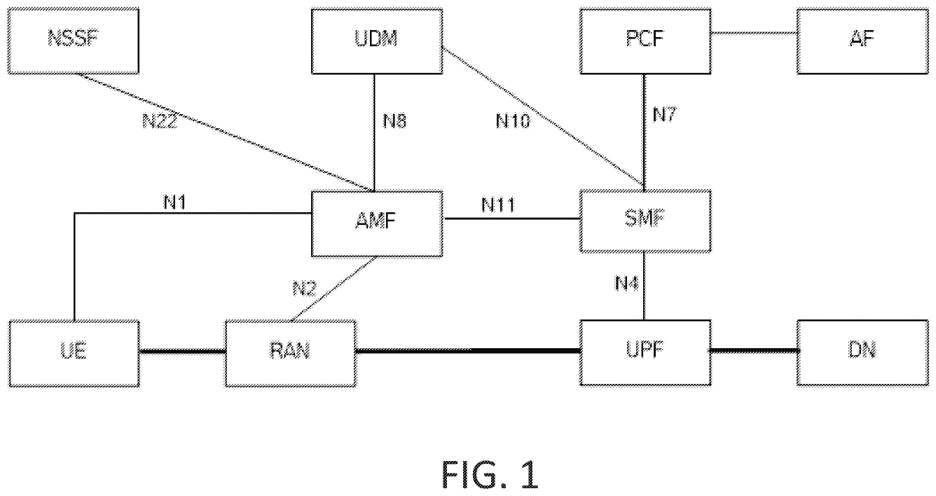

FIG. 1 shows 5G System (5GS) architecture. In an embodiment, 5GS architecture consists of the following network functions (NFs):

1) UE, User Equipment.

2) RAN, Radio Access Network.

3) AMF, Access and Mobility Management Function. This network function (NF) includes functionalities such as UE Mobility Management, Reachability Management, Connection Management and Registration Management. The AMF terminates the RAN (radio access network) control plane (CP) interface N2 and NAS (non-access stratum) interface N1, NAS ciphering and integrity protection. It also distributes the SM (Structural-to-Modular) NAS to the proper SMFs (Session Management Functions) via N11 interface.

During the Registration procedure, the AMF may determine the Allowed NSSAI (network slice Selection Assistance information) and the Rejected NSSAI with rejection cause based on the Requested NSSAI received from the UE. The AMF further determines the Registration Area within which the UE can use all S-NSSAIs (Single-network slice Selection Assistance information) of the Allowed NSSAI. The AMF sends the Allowed NSSAI, the Rejected NSSAI with rejection cause and the Registration Area to the UE.

4) UDM, Unified Data Management. This NF manages the subscription profile for the UEs. The subscription data is stored in the Unified Data Repository (UDR). The subscription information includes the data used for Mobility Management and Session Management. The AMF and SMF (Session Management Function) retrieve the subscription data from the UDM.

5) NSSF, network slice Selection Function. This NF supports the following functionality: selecting the set of network slice instances serving the UE; determining the Allowed NSSAI and, if needed, the mapping to the HPLMN S-NSSAIs; determining the Configured NSSAI and, if needed, the mapping to the HPLMN S-NSSAIs; determining the AMF Set to be used to serve the UE, or, based on a configuration, a list of candidate AMF(s), possibly by querying the Network Repository Function (NRF).

In the case of home-routed roaming, there are two main options depending on the operators' choices in terms of involvement of the NRF, the NSSF and the configuration of the AMF. One option is that the HPLMN and the VPLMN deploy an NSSF separately (referred to as vNSSF and hNSSF).

6) SMF, Session Management Function. This NF includes the following functionalities: session establishment, modification and release; UE IP address allocation and management; selection and control of user plane (UP) function, etc.

7) UPF, User Plane Function. This NF serves as an anchor point for intra-/inter-radio access technology (RAT) mobility and as the external PDU session point of interconnect to the Data Network (DN). The UPF also routes and forwards the data packet according to the indication from the SMF. It also buffers the downlink (DL) data when the UE is in an idle mode.

8) AF, Application Function. This NF interacts with the 3GPP Core Network in order to provide services, for example, to support application influence on traffic routing, accessing NEF, interacting with the policy framework for policy control, etc.

9) PCF, Policy Control Function. This NF supports unified policy framework to govern network behavior. The PCF provides access management policy to the AMF, or session management policy to the SMF, or UE policy to the UE. The PCF can access the UDR to obtain the subscription information relevant for policy decisions.

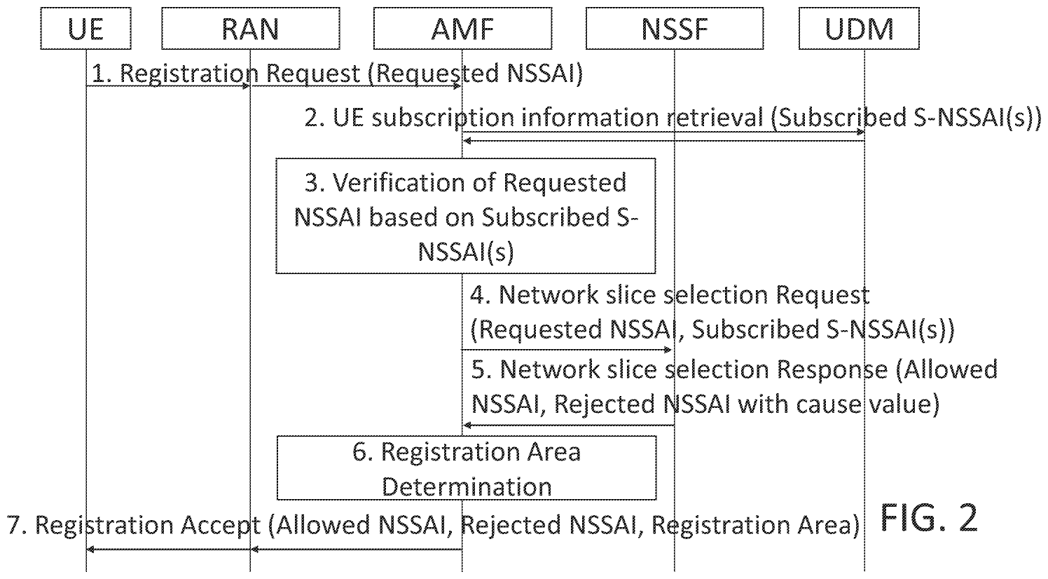

FIG. 2 shows a procedure for a UE registering for a set of network slices.

1. When a UE registers over an Access Type with a PLMN, the UE may provide the network in NAS layer, a Requested NSSAI containing the S-NSSAI(s) corresponding to the network slice(s) which the UE requests to register for. The Requested NSSAI may be at least one of:
the Default Configured NSSAI, e.g., if the UE has neither Configured NSSAI nor Allowed NSSAI for the serving PLMN;
the Configured-NSSAI, or a subset thereof, e.g. if the UE has no Allowed NSSAI for the Access Type for the serving PLMN;
the Allowed-NSSAI for the Access Type over which the Requested NSSAI is sent or a subset thereof; or
the Allowed-NSSAI for the Access Type over which the Requested NSSAI is sent or a subset thereof, and one or more S-NSSAIs from the Configured-NSSAI are not in the Allowed NSSAI for the Access Type.

2. When the AMF selected by the RAN during Registration Procedure receives the UE Registration request, the AMF may query the UDM to retrieve UE subscription information including the Subscribed S-NSSAIs.

3. The AMF verifies whether the S-NSSAI(s) in the Requested NSSAI are permitted based on the Subscribed S-NSSAIs. To identify the Subscribed S-NSSAIs, the AMF may use the mapped HPLMN S-NSSAIs provided by the UE in the NAS.

4. When the UE context in the AMF does not include an Allowed NSSAI for the corresponding Access Type, the AMF queries the NSSF for network slice selection, unless the AMF is allowed to determine whether it can serve the UE based on configuration of the AMF. The IP address or FQDN (Fully Qualified Domain Name) of the NSSF is locally configured in the AMF.

5. The NSSF returns the AMF the Allowed NSSAI. The NSSF may also return the Rejected S-NSSAI(s) with rejection cause indicating the reason why the S-NSSAI(s) is rejected, e.g., rejected NSSAI for the current PLMN, rejected NSSAI for the current Registration Area, etc.

6. The AMF may determine a Registration Area such that all S-NSSAIs in the Allowed NSSAI are available in all Tracking Areas of the Registration Area.

7. The AMF sends a Registration Accept message to the UE including the Allowed NSSAI, the mapped HPLMN NSSAI of the Allowed NSSAI (if it is provided), and the Rejected S-NSSAI(s) with rejection cause and the Registration Area.

After completion of the Registration procedure, the UE may request to establish a PDU (Protocol Data Unit) Session. The Requested S-NSSAI of the PDU Session is derived from the URSP (UE route selection policy) rules or UE Local Configuration. The Requested S-NSSAI should be within the Allowed NSSAI.

When a roaming UE activates a service and/or application requiring a network slice not offered by the serving VPLMN but available in the area from other VPLMN(s), it is unclear how to re-select another VPLMN.

Embodiments of the present disclosure provide a mechanism to ensure that the HPLMN can provide the UE prioritization information of the VPLMNs and/or access technology based on the network slice information, in which with the prioritization information, the UE may register for the intended network slice.

In some embodiments of the present disclosure, the VPLMN supports several access technologies and the network slice supported by each access technology may be different. In this case, the prioritization information of the VPLMNs and/or access technology may be the VPLMNs and/or access technology prioritization or the VPLMNs and/or access technology combination prioritization. In other words, the UE can select the access technology and/or the VPLMN for an intended network slice based on the prioritization information of the VPLMNs and/or access technology.

In the following paragraphs, some examples are described.

### Example 1: The Prioritization Information of the VPLMNs and/or Access Technology Provided by UDM/AF

In this example, the prioritization information of the VPLMNs and/or access technology generated based on the network slice information, with which the UE may register for the intended network slice(s), may be provided by a UDM or an AF.

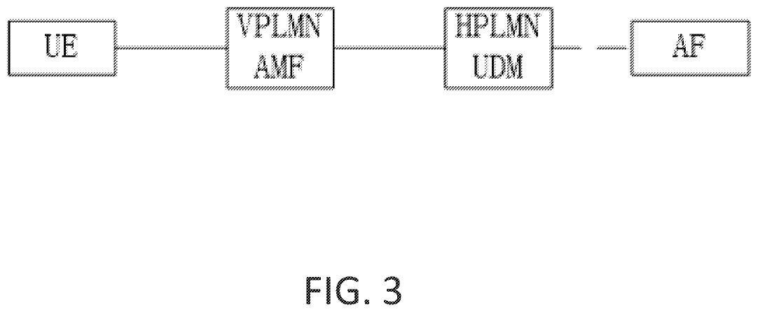

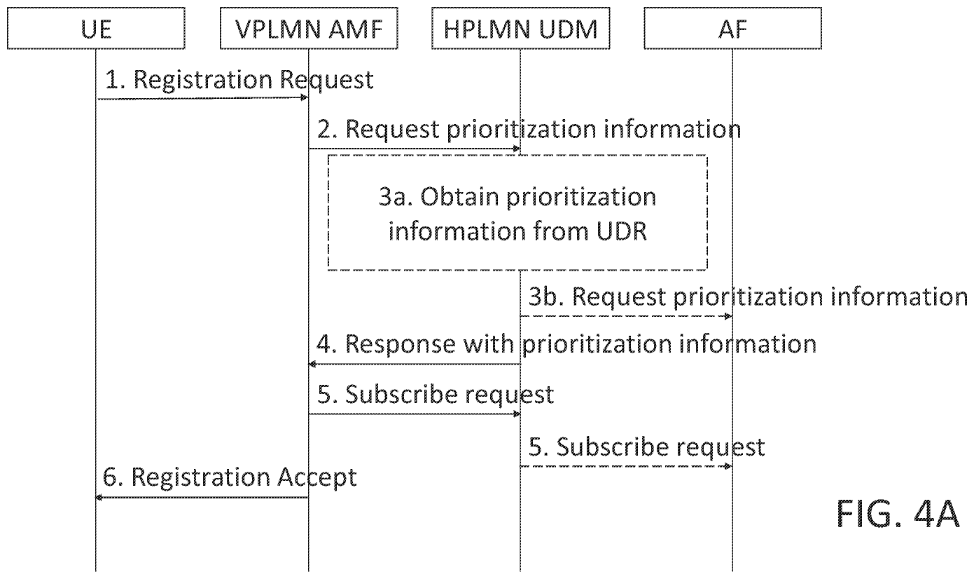

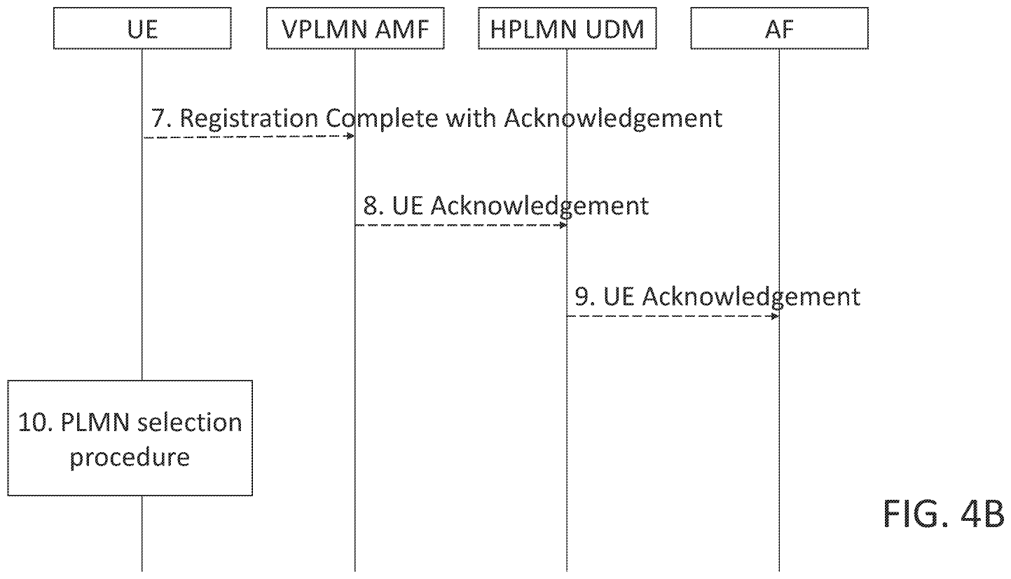

FIG. 3 shows a schematic diagram of the architecture for this example and FIG. 4 shows the registration procedure.

In this example, the AF is an NF which may be deployed in the HPLMN and used for VPLMNs and/or access technology prioritization management. The AF is deployed optionally for operators. If the AF is not deployed, the VPLMNs and/or access technology prioritization information may be managed by the UDM and/or UDR (Unified Data Repository).

In this example, the AF may be an enhanced SoR-AF configured for the VPLMNs and/or access technology prioritization management based on slice information or a new NF to perform the VPLMNs and/or access technology prioritization management based on slice information.

1. The UE initiates an initial registration procedure, an emergency registration procedure, or a mobility registration update procedure to the VPLMN AMF by sending a REGISTRATION REQUEST message with a 5GS registration type IE (information element) indicating “initial registration”, “emergency registration” or “mobility registration updating”.

In an embodiment, the UE may include the requested NSSAI containing the S-NSSAI(s) corresponding to the network slice(s) to which the UE intends to register for in the REGISTRATION REQUEST message, and include the mapped S-NSSAI(s) for the requested NSSAI, if available, in the REGISTRATION REQUEST message.

The UE may include an indication indicating that it supports PLMN selection based on prioritization information of the VPLMNs and/or access technology with which the UE may register for the intended network slice(s) in the REGISTRATION REQUEST message.

The UE includes all the S-NSSAIs associated to the network slices which the UE intends to register for. There are two options to provide such S-NSSAIs to the network:

Option 1: The UE may include the intended S-NSSAI(s) in the Requested NSSAI and an extended IE in the REGISTRATION REQUEST message. The Requested NSSAI includes the intended S-NSSAIs which are allowed by the serving PLMN and/or in the Configured NSSAI for the serving PLMN. The extended IE includes the intended S-NSSAIs, which are, e.g., previously rejected for the current PLMN and/or previously rejected for the current Registration Area.

Option 2: The UE may include all the intended S-NSSAIs in the Requested NSSAI or an extended IE in the REGISTRATION REQUEST message.

2. Upon receiving the REGISTRATION REQUEST message, the VPLMN AMF executes the registration procedure. As a part of the registration procedure, the VPLMN AMF invokes an Nudm_SDM_Get service operation with the HPLMN UDM to retrieve the prioritization information of the VPLMNs and/or access technology.

There are three options to provide the intended S-NSSAIs to the home network to retrieve the prioritization information:

Option A: The AMF provides the requested NSSAI (e.g., including all the intended S-NSSAIs, including the allowed S-NSSAIs and/or the rejected NSSAI for the current PLMN and/or the rejected NSSAI for the current Registration Area) in the Nudm_SDM_Get message.

Option B: The AMF provides the rejected NSSAI for the current PLMN and/or the rejected NSSAI for the current Registration Area included in the requested NSSAI in the Nudm_SDM_Get message.

Option C: If the UE includes the intended S-NSSAI(s) in an extended IE in the REGISTRATION REQUEST message, the AMF provides the intended S-NSSAI(s) in the extended IE in the Nudm_SDM_Get message.

3a. If the information of the VPLMNs and/or access technology and network slice(s) supported by each VPLMN is stored in the UDR, the HPLMN UDM may obtain such information from the UDR and generate the prioritization information of the VPLMNs and/or access technology with which the UE may register for the network slice(s) included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C), or the secured packet.

3b. If the information of the VPLMNs and/or access technology and network slice(s) supported by each VPLMN is stored in the AF, the HPLMN UDM may obtain the prioritization information of the VPLMNs and/or access technology, from the AF, in which with the obtained prioritization information of the VPLMNs and/or access technology the UE may register for the network slice(s) included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C), or the available secured packet.

4. The HPLMN UDM sends a response to the VPLMN AMF through the Nudm_SDM_Get service operation, in which the response includes the prioritization information of the VPLMNs and/or access technology with which the UE may register for the network slice(s) included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C).

In an embodiment, in the case of the above-mentioned Option B, the prioritization information of the VPLMNs and/or access technology may also include information of the current PLMN.

5. As part of the registration procedure, the VPLMN AMF also invokes an Nudm_SDM_Subscribe service operation with the HPLMN UDM to subscribe a notification of updates of the prioritization information of the VPLMNs and/or access technology with which the UE may register for the intended network slice(s) from the HPLMN UDM.

6. The prioritization information of the VPLMNs and/or access technology may be transparent to the AMF. In this case, when the AMF receives the response from the HPLMN UDM including the prioritization information, the AMF sends the prioritization information to the UE in the REGISTRATION ACCEPT message without acknowledging the content of the prioritization information.

In an alternative embodiment, the prioritization information of the VPLMNs and/or access technology may not be transparent to the AMF. In this case, the VPLMN AMF may acknowledge the content of the prioritization information send the received prioritization information of the VPLMNs and/or access technology to the UE in the REGISTRATION ACCEPT message.

7. If the UDM has requested an acknowledgement from the UE and the UE verified that the prioritization information of the VPLMNs and/or access technology has been provided by the HPLMN, the UE sends the REGISTRATION COMPLETE message to the serving AMF with the UE acknowledgement.

8. If the UE acknowledgement is received in the REGISTRATION COMPLETE message, the AMF uses the Nudm_SDM_Info service operation to provide the received UE acknowledgement to the UDM.

9. The HPLMN UDM may inform the AF about the successful delivery of the prioritization information of the VPLMNs and/or access technology.

10. If the UE activates a service and/or an application requiring a network slice not offered by the serving VPLMN but available in the area from other VPLMNs based on the received prioritization information of the VPLMNs and/or access technology, and the UE is in an automatic network selection mode, the UE may attempt to obtain a service in a higher priority PLMN with which the UE can register for the network slice.

### Example 2: The Prioritization Information of the VPLMNs and/or Access Technology Provided by an NF

In this example, the prioritization information of the VPLMNs and/or access technology generated based on the network slice information, with which the UE may register for the intended network slice(s), may be provided by a newly defined NF. The NF, for example, is deployed in an HPLMN and used for VPLMNs and/or access technology prioritization management based on the slice information.

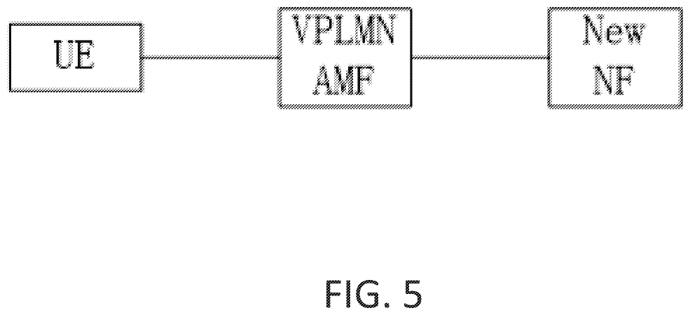

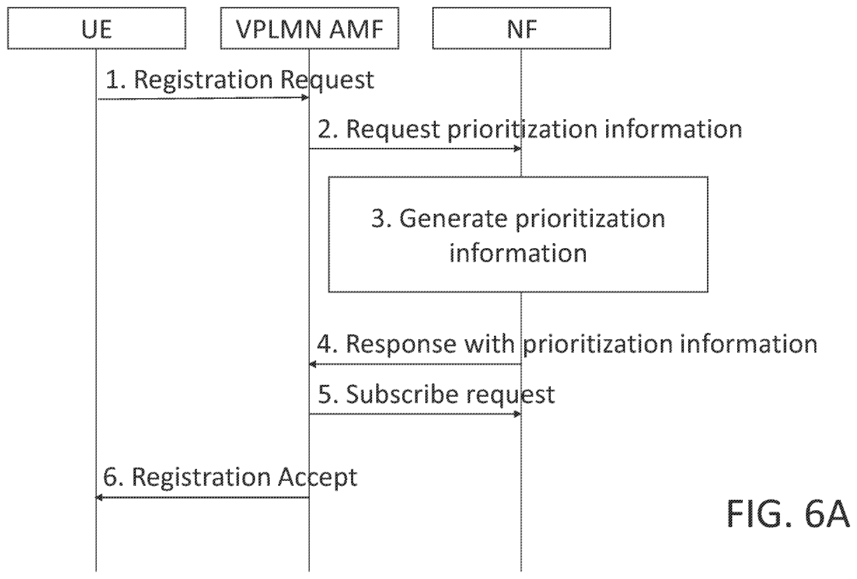

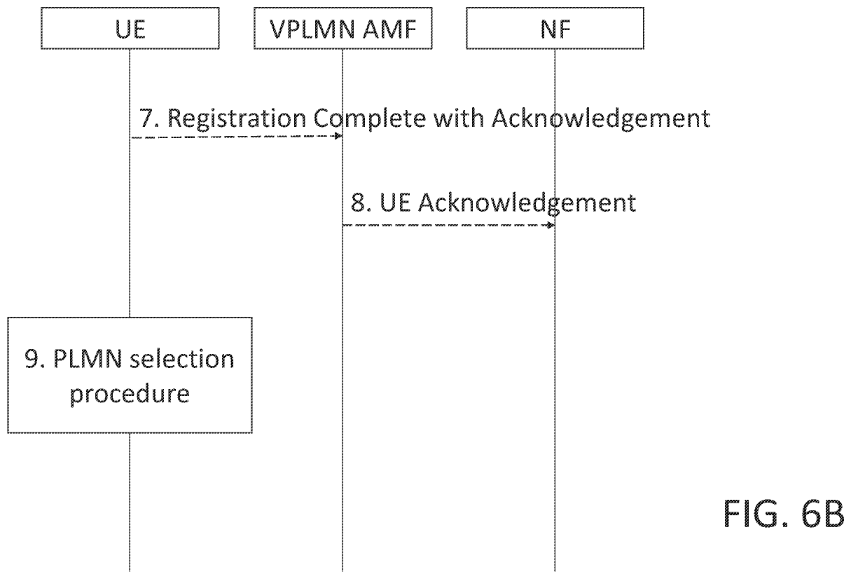

FIG. 5 shows a schematic diagram of the architecture for this example and FIG. 6 shows the registration procedure.

1. The UE initiates an initial registration procedure, an emergency registration procedure, or a mobility registration update procedure to the VPLMN AMF by sending a REGISTRATION REQUEST message with a 5GS registration type IE (information element) indicating “initial registration”, “emergency registration” or “mobility registration updating”.

In an embodiment, the UE may include the requested NS SAI containing the S-NSSAI(s) corresponding to the network slice(s) to which the UE intends to register for in the REGISTRATION REQUEST message, and include the mapped S-NSSAI(s) for the requested NSSAI, if available, in the REGISTRATION REQUEST message.

The UE may include an indication indicating that it supports PLMN selection based on prioritization information of the VPLMNs and/or access technology with which the UE may register for the intended network slice(s) in the REGISTRATION REQUEST message.

The UE includes all the S-NSSAIs associated to the network slices which the UE intends to register for. There are two options to provide such S-NSSAIs to the network:

Option 1: The UE may include the intended S-NSSAI(s) in the Requested NSSAI and an extended IE in the REGISTRATION REQUEST message. The Requested NSSAI includes the intended S-NSSAIs which are allowed by the serving PLMN and/or in the Configured NSSAI for the serving PLMN. The extended IE includes the intended S-NSSAIs, which are, e.g., previously rejected for the current PLMN and/or previously rejected for the current Registration Area.

Option 2: The UE may include all the intended S-NSSAIs in the Requested NSSAI or an extended IE in the REGISTRATION REQUEST message.

2. Upon receiving the REGISTRATION REQUEST message, the VPLMN AMF executes the registration procedure. As a part of the registration procedure, the VPLMN AMF sends a request message to the NF to retrieve the prioritization information of the VPLMNs and/or access technology.

There are three options to provide the intended S-NSSAIs to the NF to retrieve the prioritization information of the VPLMNs and/or access technology:

Option A: The AMF provides the requested NSSAI (e.g., including all the intended S-NSSAIs, including the allowed S-NSSAIs and/or the rejected NSSAI for the current PLMN and/or the rejected NSSAI for the current Registration Area) in the request message to the NF.

Option B: The AMF provides the rejected NSSAI for the current PLMN and/or the rejected NSSAI for the current Registration Area included in the requested NSSAI in the request message to the NF.

Option C: If the UE includes the intended S-NSSAI(s) in an extended IE in the REGISTRATION REQUEST message, the AMF provides the intended S-NSSAI(s) in the extended IE in the request message to the NF.

3. The NF generates the prioritization information of the VPLMNs and/or access technology with which the UE may register for the network slice(s) included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C), or the secured packet.

4. The NF sends a response to the VPLMN which includes the prioritization information of the VPLMNs and/or access technology with which the UE may register for the network slice(s) included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C).

In an embodiment, in the case of the above-mentioned Option B, the prioritization information of the VPLMNs and/or access technology may also include information of the current PLMN.

5. The VPLMN AMF invokes an subscribe service operation to the NF to subscribe a notification of updates of the prioritization information of the VPLMNs and/or access technology with which the UE may register for the intended network slice(s).

6. The prioritization information of the VPLMNs and/or access technology may be transparent to the AMF. In this case, when the AMF receives the response from the NF including the prioritization information, the AMF sends the prioritization information to the UE in the REGISTRATION ACCEPT message without acknowledging the content of the prioritization information.

In another case, the VPLMN AMF may acknowledge the content of the prioritization information send the received prioritization information of the VPLMNs and/or access technology to the UE in the REGISTRATION ACCEPT message.

7. If the NF has requested an acknowledgement from the UE and the UE verified that the prioritization information of the VPLMNs and/or access technology has been provided by the HPLMN, the UE sends the REGISTRATION COMPLETE message to the serving AMF with the UE acknowledgement.

8. If the UE acknowledgement is received in the REGISTRATION COMPLETE message, the AMF will provide the received UE acknowledgement to the NF.

9. If the UE activates a service and/or an application requiring a network slice not offered by the serving VPLMN but available in the area from other VPLMNs based on the received prioritization information of the VPLMNs and/or access technology, and the UE is in an automatic network selection mode, the UE may attempt to obtain a service in a higher priority PLMN with which the UE can register for the network slice.

### Example 3: The Prioritization Information of the VPLMNs and/or Access Technology Provided by an NSSF

In this example, the prioritization information of the VPLMNs and/or access technology generated based on the network slice information, with which the UE may register for the intended network slice(s), may be provided by an NSSF.

In some situations (e.g., in case of home-routed roaming), HPLMN and VPLMN may deploy NSSFs separately, and which are hNSSF (home network slice Selection Function) and vNSSF (visitor network slice Selection Function).

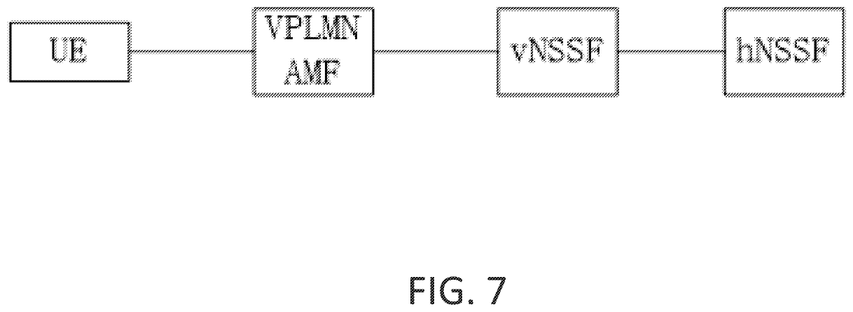

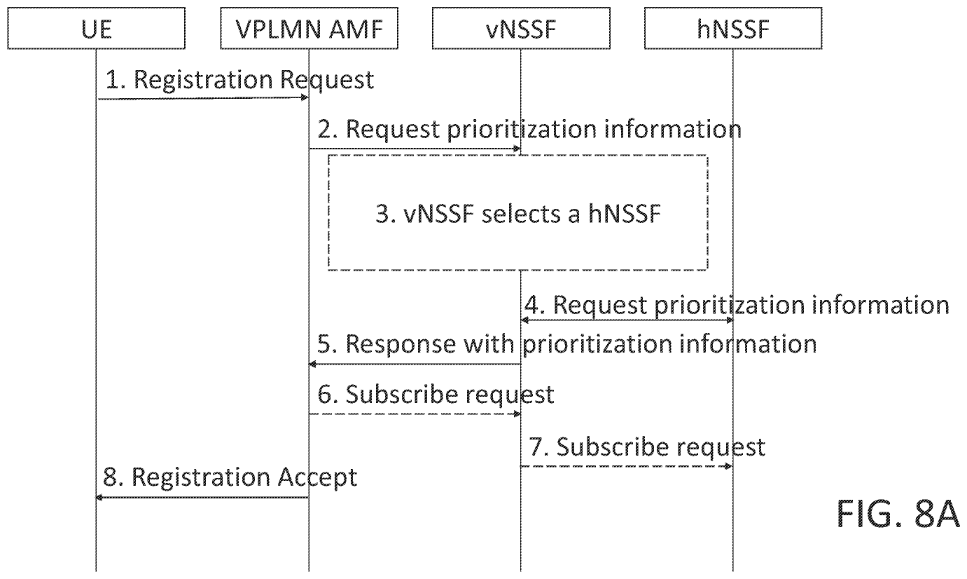

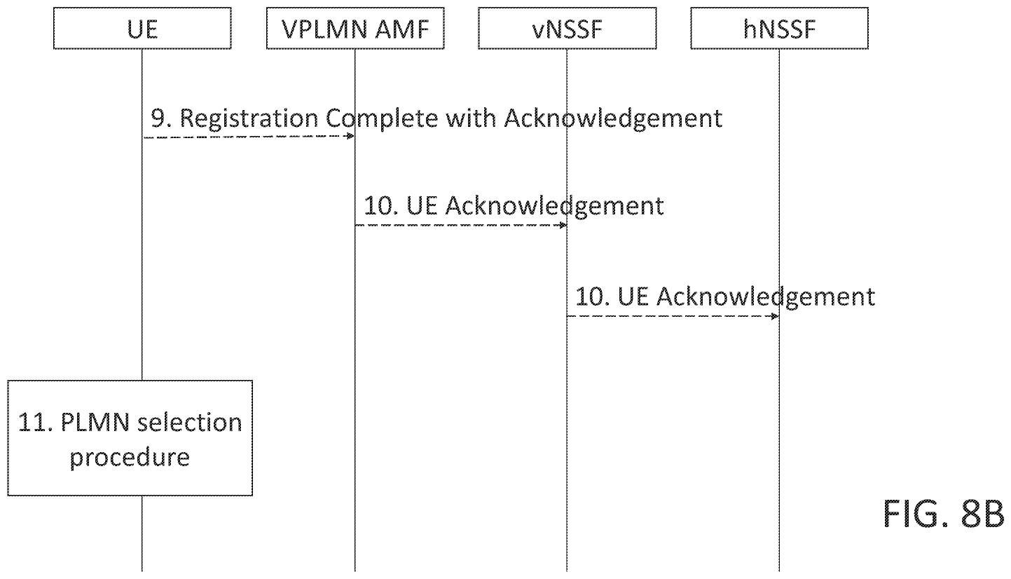

FIG. 7 shows a schematic diagram of the architecture for this example and FIG. 8 shows the registration procedure.

1. The UE initiates an initial registration procedure, an emergency registration procedure, or a mobility registration update procedure to the VPLMN AMF by sending a REGISTRATION REQUEST message with a 5GS registration type IE (information element) indicating “initial registration”, “emergency registration” or “mobility registration updating”.

In an embodiment, the UE may include the requested NSSAI containing the S-NSSAI(s) corresponding to the network slice(s) to which the UE intends to register for in the REGISTRATION REQUEST message, and include the mapped S-NSSAI(s) for the requested NSSAI, if available, in the REGISTRATION REQUEST message.

The UE may include an indication indicating that it supports PLMN selection based on prioritization information of the VPLMNs and/or access technology with which the UE may register for the intended network slice(s) in the REGISTRATION REQUEST message.

The UE includes all the S-NSSAIs associated to the network slices which the UE intends to register for. There are two options to provide such S-NSSAIs to the network:

Option 1: The UE may include the intended S-NSSAI(s) in the Requested NSSAI and an extended IE in the REGISTRATION REQUEST message. The Requested NSSAI includes the intended S-NSSAIs which are allowed by the serving PLMN and/or in the Configured NSSAI for the serving PLMN. The extended IE includes the intended S-NSSAIs, which are, e.g., previously rejected for the current PLMN and/or previously rejected for the current Registration Area.

Option 2: The UE may include all the intended S-NSSAIs in the Requested NSSAI or an extended IE in the REGISTRATION REQUEST message.

2. Upon receiving the REGISTRATION REQUEST message, the VPLMN AMF executes the registration procedure. As a part of the registration procedure, the VPLMN AMF sends a request message to the vNSSF to retrieve the prioritization information of the VPLMNs and/or access technology.

There are three options to provide the intended S-NSSAIs to the vNSSF:

Option A: The AMF provides the requested NSSAI (e.g., including all the intended S-NSSAIs, including the allowed S-NSSAIs and/or the rejected NSSAI for the current PLMN and/or the rejected NSSAI for the current Registration Area) in the request message to the vNSSF.

Option B: The AMF provides the rejected NSSAI for the current PLMN and/or the rejected NSSAI for the current Registration Area included in the requested NSSAI in the request message to the vNSSF.

Option C: If the UE includes the intended S-NSSAI(s) in an extended IE in the REGISTRATION REQUEST message, the AMF provides the intended S-NSSAI(s) in the request message to the vNSSF.

3. The vNSSF selects an hNSSF to retrieve the prioritization information. An NRF may be queried during hNSSF selection. If there are several level NRFs, the query procedure may involve several levels of NRF according to the network implementation of the operator.

4. Upon reception of the request message from the AMF in step 2, the vNSSF sends a request to the hNSSF selected in step 3 to retrieve the prioritization information. Also, the vNSSF forwards the information (e.g., including the intended S-NSSAI(s)) received from the AMF to the hNSSF.

The hNSSF generates the prioritization information with which the UE may register for the network slice(s) included in the requested NSSAI (above Option A) or included in the rejected NSSAI for the current PLMN and/or the rejected NSSAI for the current Registration Area (above Option B) or included in the extended (new) IE (above Option C), or the secured packet.

The hNSSF sends a response to the vNSSF, which includes the prioritization information of the VPLMNs and/or access technology with which the UE may register for the network slice(s) included in the included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C).

In an embodiment, in the case of the above-mentioned Option B, the prioritization information of the VPLMNs and/or access technology may also include information of the current PLMN.

5. The vNSSF forwards the prioritization information to the AMF.

The prioritization information may be transparent to the vNSSF and AMF. In this case, when the vNSSF and the AMF receive the response including the prioritization information, the vNSSF and the AMF may send the prioritization information to the UE without acknowledging the content of the prioritization information.

In another case, the vNSSF and the AMF may acknowledge the content of the prioritization information when sending the received prioritization information to the UE.

6. The VPLMN AMF may invoke a subscribe service operation to the vNSSF to subscribe a notification of updates of the prioritization information of the VPLMNs and/or access technology with which the UE may register for the intended network slice(s) from the vNSSF.

7. If the AMF subscribes the notification of updates of the prioritization from the vNSSF, the vNSSF may subscribe a notification of updates of the prioritization information from the hNSSF.

8. The VPLMN AMF may transparently send the received prioritization information to the UE in the REGISTRATION ACCEPT message.

In another case, the VPLMN AMF may send the received prioritization information to the UE in the REGISTRATION ACCEPT message with acknowledgement of the content of the prioritization information.

9. If the hNSSF requests an acknowledgement from the UE and the UE verified that the prioritization information of the VPLMNs and/or access technology is received from the HPLMN, the UE sends the REGISTRATION COMPLETE message with the UE acknowledgement to the serving AMF.

10. If the UE acknowledgement in the REGISTRATION COMPLETE message is received, the AMF provides the received UE acknowledgement to the vNSSF.

11. If the UE acknowledgement from the AMF is received, the vNSSF provides the received UE acknowledgement to the hNSSF.

12. If the UE activates a service and/or an application requiring a network slice not offered by the serving VPLMN but available in the area from other VPLMNs based on the received prioritization information of the VPLMNs and/or access technology, and the UE is in an automatic network selection mode, the UE may attempt to obtain a service in a higher priority PLMN with which the UE can register for the network slice.

### Example 4: The Prioritization Information of the VPLMNs and/or Access Technology Provided by a PCF

In this example, the prioritization information of the VPLMNs and/or access technology generated based on the network slice information, with which the UE may register for the intended network slice(s), may be provided by the PCF in the HPLMN. The PCF in the HPLMN (also referred to as hPCF) manages the prioritization information of the VPLMNs and/or access technology and network slice(s) supported by each VPLMN.

In this example, the PCF in the VPLMN is also deployed (referred to as vPCF).

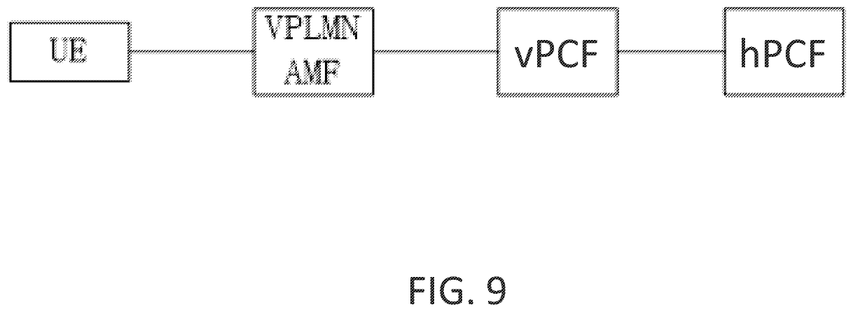

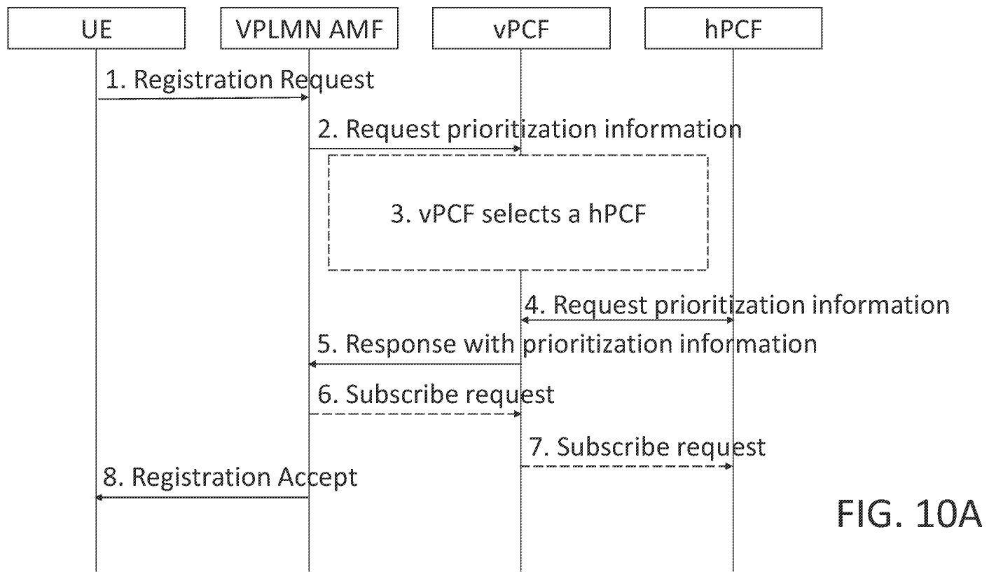

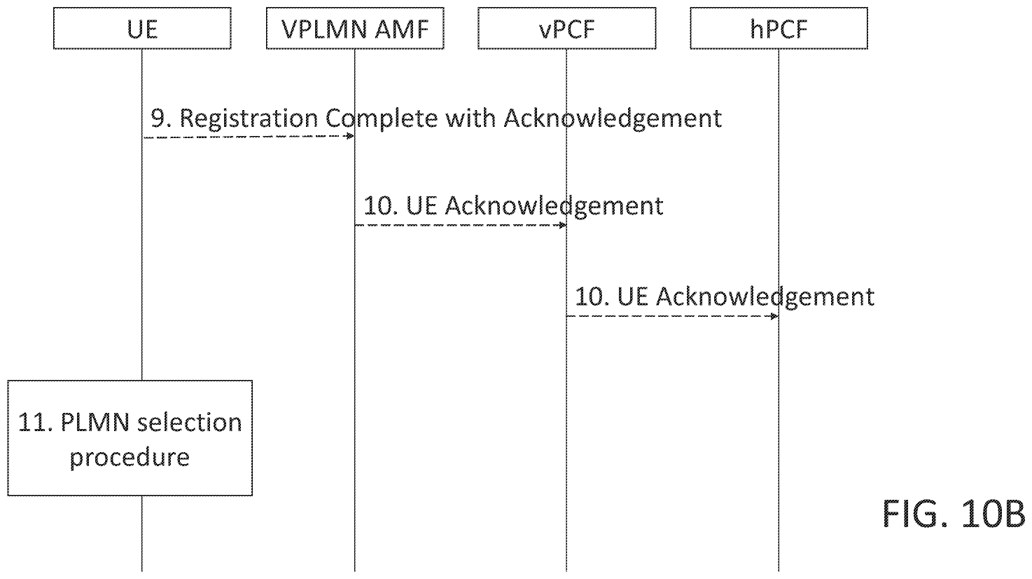

FIG. 9 shows a schematic diagram of the architecture for this example and FIG. 10 shows the registration procedure.

1. The UE initiates an initial registration procedure, an emergency registration procedure, or a mobility registration update procedure to the VPLMN AMF by sending a REGISTRATION REQUEST message with a 5GS registration type IE (information element) indicating “initial registration”, “emergency registration” or “mobility registration updating”.

In an embodiment, the UE may include the requested NSSAI containing the S-NSSAI(s) corresponding to the network slice(s) to which the UE intends to register for in the REGISTRATION REQUEST message, and include the mapped S-NSSAI(s) for the requested NSSAI, if available, in the REGISTRATION REQUEST message.

The UE may include an indication indicating that it supports PLMN selection based on prioritization information of the VPLMNs and/or access technology with which the UE may register for the intended network slice(s) in the REGISTRATION REQUEST message.

The UE includes all the S-NSSAIs associated to the network slices which the UE intends to register for. There are two options to provide such S-NSSAIs to the network:

Option 1: The UE may include the intended S-NSSAI(s) in the Requested NSSAI and an extended IE in the REGISTRATION REQUEST message. The Requested NSSAI includes the intended S-NSSAIs which are allowed by the serving PLMN and/or in the Configured NSSAI for the serving PLMN. The extended IE includes the intended S-NSSAIs, which are, e.g., previously rejected for the current PLMN and/or previously rejected for the current Registration Area.

Option 2: The UE may include all the intended S-NSSAIs in the Requested NSSAI or an extended IE in the REGISTRATION REQUEST message.

2. Upon receiving the REGISTRATION REQUEST message, the VPLMN AMF executes the registration procedure. As a part of the registration procedure, the VPLMN AMF sends a request message to the vPCF to retrieve the prioritization information of the VPLMNs and/or access technology.

There are three options to provide the intended S-NSSAIs to the vPCF:

Option A: The AMF provides the requested NSSAI (e.g., including all the intended S-NSSAIs, including the allowed S-NSSAIs and/or the rejected NSSAI for the current PLMN and/or the rejected NSSAI for the current Registration Area) in the request message to the vPCF.

Option B: The AMF provides the rejected NSSAI for the current PLMN and/or the rejected NSSAI for the current Registration Area included in the requested NSSAI in the request message to the vPCF.

Option C: If the UE includes the intended S-NSSAI(s) in an extended IE in the REGISTRATION REQUEST message, the AMF provides the intended S-NSSAI(s) in the request message to the vPCF.

3. The vPCF selects an hPCF to retrieve the prioritization information. An NRF may be queried during hPCF selection. If there are several level NRFs, the query procedure may involve several levels of NRF according to the network implementation of the operator.

4. Upon reception of the request message from the AMF in step 2, the vPCF sends a request to the hPCF selected in step 3 to retrieve the prioritization information. Also, the vPCF forwards the information (e.g., including the intended S-NSSAI(s)) received from the AMF to the hPCF.

The hPCF generates the prioritization information with which the UE may register for the network slice(s) included in the requested NSSAI (above Option A) or included in the rejected NSSAI for the current PLMN and/or the rejected NSSAI for the current Registration Area (above Option B) or included in the extended (new) IE (above Option C), or the secured packet.

The hPCF sends a response to the vPCF, which includes the prioritization information of the VPLMNs and/or access technology with which the UE may register for the network slice(s) included in the included in the requested NSSAI (in the case of the above-mentioned Option A) or included in the rejected NSSAI for the current PLMN and/or the rejected NSSAI for the current Registration Area (in the case of the above-mentioned Option B) or included in the extended IE (in the case of the above-mentioned Option C).

In an embodiment, in the case of the above-mentioned Option B, the prioritization information of the VPLMNs and/or access technology may also include information of the current PLMN.

5. The vPCF forwards the prioritization information to the AMF.

The prioritization information may be transparent to the vPCF and the AMF. In this case, when the vPCF and the AMF receive the response including the prioritization information, the vPCF and the AMF may send the prioritization information to the UE without acknowledging the content of the prioritization information.

In another case, the vPCF and the AMF may acknowledge the content of the prioritization information when sending the received prioritization information to the UE.

6. The VPLMN AMF may invoke a subscribe service operation to the vPCF to subscribe a notification of updates of the prioritization information of the VPLMNs and/or access technology with which the UE may register for the intended network slice(s) from the vPCF.

7. If the AMF subscribes the notification of updates of the prioritization from the vPCF, the vPCF may subscribe a notification of updates of the prioritization information from the hPCF.

8. The VPLMN AMF may transparently send the received prioritization information to the UE in the REGISTRATION ACCEPT message.

In another case, the VPLMN AMF may send the received prioritization information to the UE in the REGISTRATION ACCEPT message with acknowledgement of the content of the prioritization information.

9. If the hPCF requests an acknowledgement from the UE and the UE verified that the prioritization information of the VPLMNs and/or access technology is received from the HPLMN, the UE sends the REGISTRATION COMPLETE message with the UE acknowledgement to the serving AMF.

10. If the UE acknowledgement in the REGISTRATION COMPLETE message is received, the AMF provides the received UE acknowledgement to the vPCF.

11. If the UE acknowledgement from the AMF is received, the vPCF provides the received UE acknowledgement to the hPCF.

12. If the UE activates a service and/or an application requiring a network slice not offered by the serving VPLMN but available in the area from other VPLMNs based on the received prioritization information of the VPLMNs and/or access technology, and the UE is in an automatic network selection mode, the UE may attempt to obtain a service in a higher priority PLMN with which the UE can register for the network slice.

According to an embodiment of the present disclosure, the UE sends an indication to the AMF. In an embodiment, the indication indicates that the UE supports PLMN selection based on prioritization information of the VPLMNs and/or access technology with which the UE may register for the intended network slice(s).

According to an embodiment of the present disclosure, the UE sends the intended S-NSSAI(s) in the requested NSSAI and/or an extended new IE to the AMF. In an embodiment, the extended new IE includes the intended S-NSSAIs which, for example, were rejected for the current PLMN and/or rejected for the current Registration Area. In an alternative embodiment, the extended new IE includes all the intended S-NSSAIs including the allowed S-NSSAIs and/or S-NSSAIs included in Configured NSSAI for the serving PLMN and/or the rejected S-NSSAIs for the current PLMN and/or the rejected S-NSSAIs for the current Registration Area.

According to an embodiment of the present disclosure, the UE receives the prioritization information of the VPLMNs and/or access technology with which the UE may register for the intended network slice(s) from the AMF.

According to an embodiment of the present disclosure, the UE sends an acknowledgement of the successful reception of the prioritization information of the VPLMNs and/or access technology with which the UE may register for the intended network slice(s) to the AMF, if required.

According to an embodiment of the present disclosure, the AMF receives the indication from the UE. In an embodiment, the indication indicates that the UE supports PLMN selection based on the prioritization information of the VPLMNs and/or access technology with which the UE may register for the intended network slice(s).

According to an embodiment of the present disclosure, the AMF receives the intended S-NSSAI(s) included in the requested NSSAI and/or an extended new IE from the UE. In an embodiment, the extended new IE includes the intended S-NSSAIs which, for example, were rejected for the current PLMN and/or rejected for the current Registration Area. In an alternative embodiment, the extended new IE includes all the intended S-NSSAIs including the allowed S-NSSAIs and/or S-NSSAIs included in Configured NSSAI for the serving PLMN and/or the rejected S-NSSAIs for the current PLMN and/or the rejected S-NSSAIs for the current Registration Area.

According to an embodiment of the present disclosure, the AMF interacts with the UDM, the newly defined NF, the NSSF, or the PCF to retrieve the prioritization information of the VPLMNs and/or access technology with which the UE may register for the intended network slice(s). In an embodiment, the AMF may provide the requested NSSAI including allowed S-NSSAIs and/or rejected NSSAI for the current PLMN and/or rejected NSSAI for the current Registration Area. In an embodiment, the AMF may provide the rejected NSSAI for the current PLMN and/or rejected NSSAI for the current Registration Area which were included in the requested NSSAI. In an embodiment, the AMF may provide the intended S-NSSAI(s) in the extended new IE from the UE.

According to an embodiment of the present disclosure, the AMF sends the prioritization information of the VPLMNs and/or access technology with which the UE may register for the intended network slice(s) to the UE.

According to an embodiment of the present disclosure, the AMF conditionally receives the acknowledgement of the successful reception of the prioritization information of the VPLMNs and/or access technology with which the UE may register for the intended network slice(s) from the UE.

According to an embodiment of the present disclosure, the UDM provides the prioritization information of the VPLMNs and/or access technology with which the UE may register for the intended network slice(s). In an embodiment, the UDM generates the prioritization information of the VPLMNs and/or access technology based on the slice information provided by the AMF or the UE. In an embodiment, the UDM interacts with an AF to retrieve the prioritization information of the VPLMNs and/or access technology with which the UE may register for the intended network slice(s). The UDM sends the slice information provided by the AMF or the UE to the AF.

According to an embodiment of the present disclosure, the UDM sends the prioritization information of the VPLMNs and/or access technology with which the UE may register for the intended network slice(s) to the AMF or the UE.

According to an embodiment of the present disclosure, the AF generates the prioritization information of the VPLMNs and/or access technology based on the slice information provided by the UDM.

According to an embodiment of the present disclosure, a new NF, an hNSSF, or an hPCF generates the prioritization information of the VPLMNs and/or access technology based on the slice information provided by the AMF or the UE.

According to an embodiment of the present disclosure, a new NF, an hNSSF, or an hPCF sends the prioritization information of the VPLMNs and/or access technology with which the UE may register for the intended network slice(s) to the AMF or the UE.

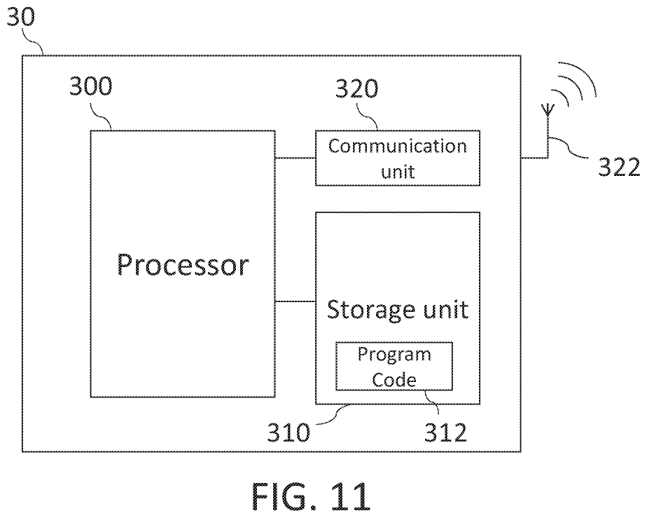

FIG. 11 relates to a schematic diagram of a wireless communication terminal 30 (e.g., a terminal node or a terminal device) according to an embodiment of the present disclosure. The wireless communication terminal 30 may be a user equipment (UE), a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described above. In some embodiments, the processor 300 and the communication unit 320 collaboratively perform the operations described above. For example, the processor 300 performs operations and transmit or receive signals, message, and/or information through the communication unit 320.

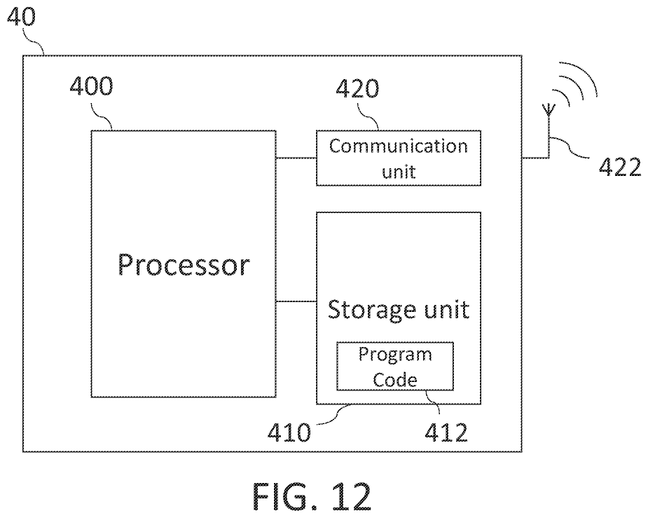

FIG. 12 relates to a schematic diagram of a wireless communication node 40 (e.g., a network device) according to an embodiment of the present disclosure. The wireless communication node 40 may be a satellite, a base station (BS) (e.g., a gNB or a gNB-CU-CP), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), an Unified Data Management (UDM), a network slice Selection Function (NSSF) etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node and/or a wireless communication terminal.

In some embodiments, the wireless communication node 40 may be used to perform the operations of the AMF, the UDM, the AF, the newly defined NF, the hNSSF, the vNSSF, the hPCF, and the vPCF described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described above, but is not limited thereto.

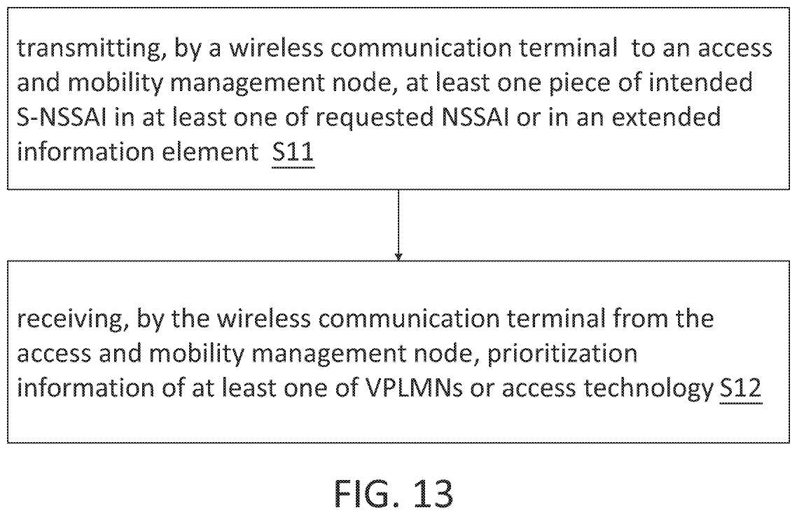

Referring to FIG. 13, in an embodiment, the wireless communication method includes: transmitting, by a wireless communication terminal to an access and mobility management node, at least one piece of intended Single-network slice Selection Assistant Information, S-NSSAI, in at least one of requested network slice Selection Assistant Information, NSSAI, or in an extended information element (S11); and receiving, by the wireless communication terminal from the access and mobility management node, prioritization information of at least one of Visitor Public Land Mobile Networks, VPLMNs, or access technology, wherein the prioritization information is generated according to the at least one piece of intended S-NSSAI in the at least one of requested NSSAI or in the extended information element (S12). In an embodiment, the wireless communication terminal may be the UE described above. In an embodiment, the access and mobility management node may be the AMF described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an AMF). In an embodiment, the wireless communication node may be implemented by using the wireless communication node 40 described above, but is not limited thereto.

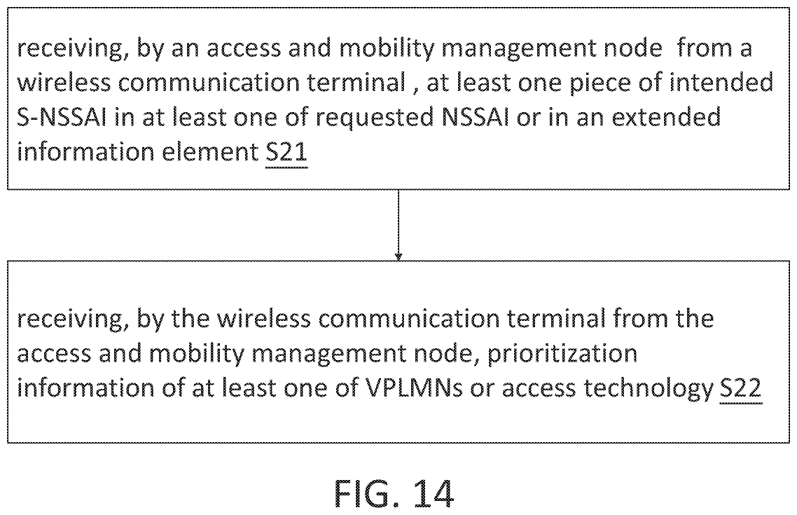

Referring to FIG. 14, in an embodiment, the wireless communication method includes: receiving, by an access and mobility management node from a wireless communication terminal, at least one piece of intended Single-network slice Selection Assistant Information, S-NSSAI, in at least one of requested network slice Selection Assistant Information, NSSAI, or in an extended information element (S21); and acquiring, by the access and mobility management node from a managing node, prioritization information of at least one of Visitor Public Land Mobile Networks, VPLMNs, or access technology by providing the managing node with the at least one piece of intended S-NSSAI in the at least one of requested NSSAI or in the extended information element (S22). In an embodiment, the wireless communication terminal may be the UE described above. In an embodiment, the access and mobility management node may be the AMF described above. In an embodiment, the managing node may be the UDM, the newly defined NF, the vNSSF, or the vPCF described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an UDM). In an embodiment, the wireless communication node may be implemented by using the wireless communication node 40 described above, but is not limited thereto.

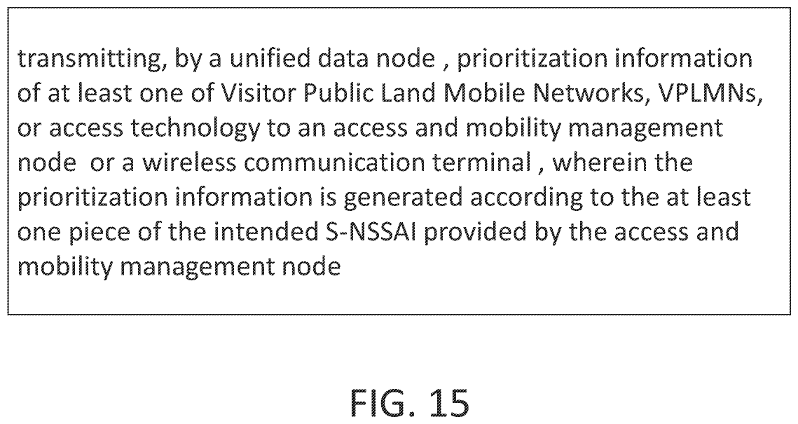

Referring to FIG. 15, in an embodiment, the wireless communication method includes: transmitting, by a unified data node, prioritization information of at least one of Visitor Public Land Mobile Networks, VPLMNs, or access technology to an access and mobility management node or a wireless communication terminal, wherein the prioritization information is generated according to the at least one piece of the intended S-NSSAI provided by the access and mobility management node. In an embodiment, the wireless communication terminal may be the UE described above. In an embodiment, the access and mobility management node may be the AMF described above. In an embodiment, the unified data node may be the UDM described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an AF). In an embodiment, the wireless communication node may be implemented by using the wireless communication node 40 described above, but is not limited thereto.

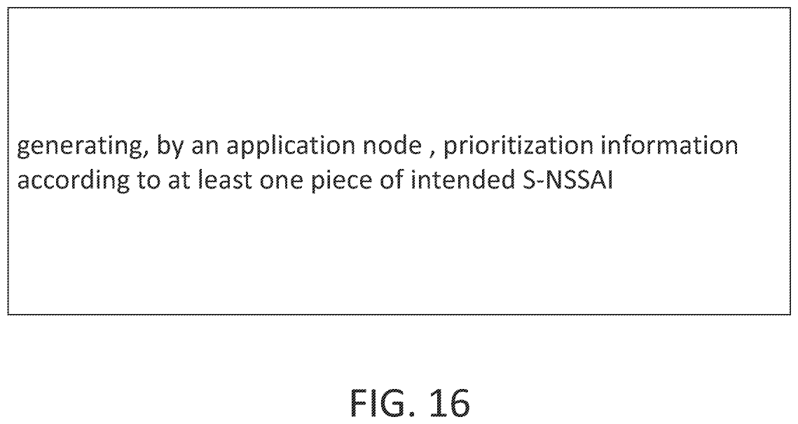

Referring to FIG. 16, in an embodiment, the wireless communication method includes: generating, by an application node, prioritization information according to at least one piece of intended S-NSSAI. In an embodiment, the application node may be the AF described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an NF). In an embodiment, the wireless communication node may be implemented by using the wireless communication node 40 described above, but is not limited thereto.

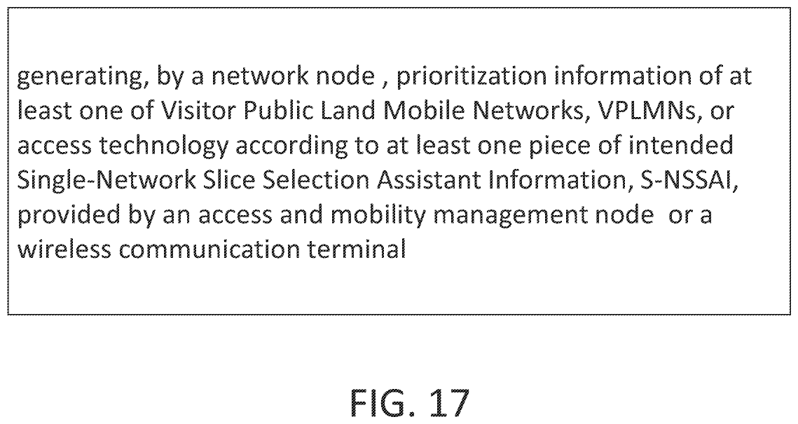

Referring to FIG. 17, in an embodiment, the wireless communication method includes: generating, by a network node, prioritization information of at least one of Visitor Public Land Mobile Networks, VPLMNs, or access technology according to at least one piece of intended Single-network slice Selection Assistant Information, S-NSSAI, provided by an access and mobility management node or a wireless communication terminal. In an embodiment, the wireless communication terminal may be the UE described above. In an embodiment, the access and mobility management node may be the AMF described above. In an embodiment, the network node may be the newly defined NF described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a vNSSF or a vPCF). In an embodiment, the wireless communication node may be implemented by using the wireless communication node 40 described above, but is not limited thereto.

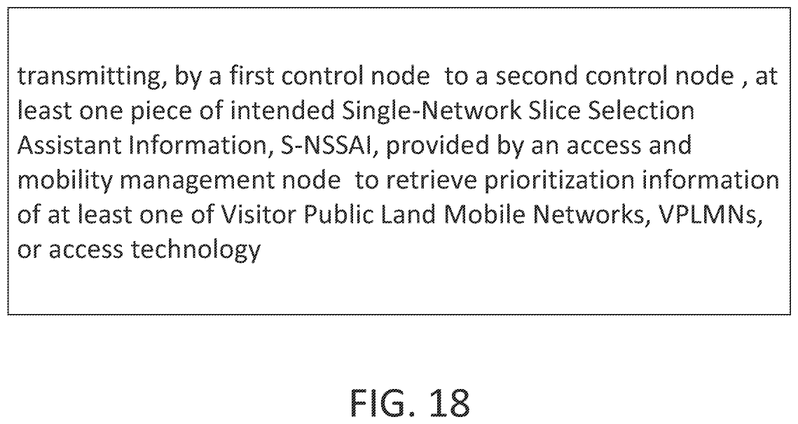

Referring to FIG. 18, in an embodiment, the wireless communication method includes: transmitting, by a first control node to a second control node, at least one piece of intended Single-network slice Selection Assistant Information, S-NSSAI, provided by an access and mobility management node to retrieve prioritization information of at least one of Visitor Public Land Mobile Networks, VPLMNs, or access technology. In an embodiment, the access and mobility management node may be the AMF described above. In an embodiment, the first control node may be the vNSSF or vPCF described above. In an embodiment, the second control node may be the hNSSF or hPCF described above.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an hNSSF or an hPCF). In an embodiment, the wireless communication node may be implemented by using the wireless communication node 40 described above, but is not limited thereto.

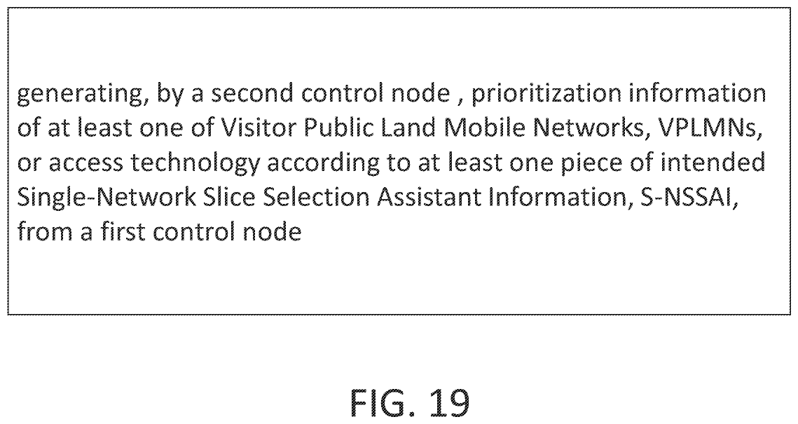

Referring to FIG. 19, in an embodiment, the wireless communication method includes: generating, by a second control node, prioritization information of at least one of Visitor Public Land Mobile Networks, VPLMNs, or access technology according to at least one piece of intended Single-network slice Selection Assistant Information, S-NSSAI, from a first control node. In an embodiment, the first control node may be the vNSSF or vPCF described above. In an embodiment, the second control node may be the hNSSF or hPCF described above.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
transmitting, by a wireless communication terminal to an access and mobility management node, at least one piece of intended Single-network slice Selection Assistant Information, S-NSSAI, in at least one of requested network slice Selection Assistant Information, NSSAI, or in an extended information element; and
receiving, by the wireless communication terminal from the access and mobility management node, prioritization information of at least one of Visitor Public Land Mobile Networks, VPLMNs, or access technology, wherein the prioritization information is generated according to the at least one piece of intended S-NSSAI in the at least one of requested NSSAI or in the extended information element.

2. The wireless communication method of claim 1, wherein the requested NSSAI comprises at least one of:
at least one piece of allowed S-NSSAI; or
at least one piece of S-NSSAI included in Configured NSSAI for a serving Public Land Mobile Network, PLMN;
and wherein the extended information element comprises at least one of:
at least one piece of rejected S-NSSAI for a current PLMN; or
at least one piece of rejected S-NSSAI for a current Registration Area.

3. The wireless communication method of claim 1, wherein the requested NSSAI or the extended information element comprises at least one of:
at least one piece of allowed S-NSSAI;
at least one piece of S-NSSAI included in Configured NSSAI for a serving PLMN;
at least one piece of rejected S-NSSAI for a current PLMN; or
at least one piece of rejected S-NSSAI for a current Registration Area.

4. The wireless communication method of claim 1, wherein the wireless communication terminal is configured to transmit an indication indicating that the wireless communication terminal supports PLMN selection based on the prioritization information.

5. A wireless communication method comprising:
receiving, by an access and mobility management node from a wireless communication terminal, at least one piece of intended Single-network slice Selection Assistant Information, S-NSSAI, in at least one of requested network slice Selection Assistant Information, NSSAI, or in an extended information element; and
acquiring, by the access and mobility management node from a managing node, prioritization information of at least one of Visitor Public Land Mobile Networks, VPLMNs, or access technology by providing the managing node with the at least one piece of intended S-NS SAI in the at least one of requested NS SAI or in the extended information element.

6. The wireless communication method of claim 5, wherein the requested NSSAI comprises at least one of:
at least one piece of allowed S-NSSAI; or
at least one piece of S-NSSAI included in Configured NSSAI for a serving PLMN;
and wherein the extended information element comprises at least one of:
at least one piece of rejected S-NS SAI for a current Public Land Mobile Network, PLMN; or
at least one piece of rejected S-NSSAI for a current Registration Area.

7. The wireless communication method of claim 5, wherein the requested NSSAI or the extended information element comprises at least one of:
at least one piece of allowed S-NSSAI;
at least one piece of S-NSSAI included in Configured NSSAI for a serving Public Land Mobile Network, PLMN;
at least one piece of rejected S-NSSAI for a current PLMN; or
at least one piece of rejected S-NSSAI for a current Registration Area.

8. The wireless communication method of claim 5, wherein the access and mobility management node is configured to receive an indication indicating that the wireless communication terminal supports PLMN selection from the wireless communication terminal based on the prioritization information.

9. The wireless communication method of claim 5, wherein the access and mobility management node is configured to provide the managing node the at least one piece of the intended S-NSSAI in the requested NSSAI or the extended information element comprising at least one of:
at least one piece of allowed S-NSSAI;
at least one piece of rejected S-NSSAI for a current PLMN; or
at least one piece of rejected S-NSSAI for a current Registration Area.

10. The wireless communication method of claim 5, wherein the access and mobility management node is configured to provide the managing node the at least one piece of the intended S-NSSAI in the requested NSSAI or the extended information element comprising at least one of:
at least one piece of rejected S-NSSAI for a current PLMN; or
at least one piece of rejected S-NSSAI for a current Registration Area.

11. The wireless communication method of claim 5, wherein the access and mobility management node is configured to transmit the prioritization information to the wireless communication terminal.

12. A wireless communication method comprising:
transmitting, by a unified data node, prioritization information of at least one of Visitor Public Land Mobile Networks, VPLMNs, or access technology to an access and mobility management node or a wireless communication terminal, wherein the prioritization information is generated according to the at least one piece of the intended S-NSSAI provided by the access and mobility management node.

13. The wireless communication method of claim 12, wherein the unified data node is configured to generate the prioritization information according to the at least one piece of the intended S-NSSAI provided by the access and mobility management node.

14. The wireless communication method of claim 12, wherein the unified data node is configured to transmit the at least one piece of the intended S-NSSAI provided by the access and mobility management node to an application node to retrieve the prioritization information from the application node.

15. The wireless communication method of claim 13, wherein the at least one piece of the intended S-NSSAI comprises at least one of:
at least one piece of allowed S-NSSAI;
at least one piece of rejected S-NS SAI for a current Public Land Mobile Network, PLMN; or
at least one piece of rejected S-NSSAI for a current Registration Area.
